(19) United States
(12) Patent Application Publication
(10) Pub. No.: US 2011/0001293 A1
(43) Pub. Date: Jan. 6, 2011

(54) SLIDABLE GASKET AND A BEARING HAVING THE SAME

(76) Inventor: Cheng Chong Chen, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/496,592

(22) Filed: Jul. 1, 2009

(51) Int. Cl. F16J 15/18

(52) U.S. Cl. 277/510

(57) ABSTRACT

A bearing of the present invention includes a slidable gasket, in which a surface thereof is formed with a slippery portion to reduce its frictional index. As such, the bearing can be disposed between two objects to reduce the friction, in which the bearing has extended service life and produces diminished noise.

### BACKGROUND OF THE INVENTION

1. Field of the Invention

The present invention relates to a bearing, and more particularly to a slippery bearing.

2. Description of the Prior Art

Bearings are used to load the weight of an object and to reduce the friction between two objects such that the objects can be rotatable about each other.

A typical type of bearing has a housing and multiple balls or rollers to lower the friction. Another type of bearing has an oil space filled with lubricating oil such that the liquid oil can reduce the friction. Both types have their own disadvantages. For the ball or roller typed bearings, the manufacturing process thereof is a problem which is rather difficult, and the balls or rollers will collide with each other or with the housing, which leads to non-smooth movement, loud noise and easily worn-out. For the oil typed bearings, the lubricating oil inevitably escapes gradually, so that it should be refilled from time to time.

### SUMMARY OF THE INVENTION

The main object of the present invention is to provide a bearing which is not easily worn out, so as to further extend its service life.

To achieve the above object, a bearing of the present invention includes a slidable gasket. The slidable gasket includes an annular main body with a slippery portion. Thereby, the bearing of the present invention achieves the slippery effect without the lubricating oil and has extended service life and lower noise.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a pictorial drawing showing a bearing in accordance with a preferred embodiment of the present invention;

FIG. 2 is an explosive drawing showing a bearing in accordance with a preferred embodiment of the present invention;

FIG. 3 is a side perspective drawing showing a bearing in accordance with a preferred embodiment of the present invention;

FIG. 4 is a profile showing a bearing in accordance with a preferred embodiment of the present invention;

FIG. 5 is a profile showing a usage state of a bearing in accordance with a preferred embodiment of the present invention;

FIG. 6 is a partial profile showing a usage state of a slidable gasket in accordance with a preferred embodiment of the present invention;

FIG. 7 is an explosive drawing showing a slidable gasket in accordance with a preferred embodiment of the present invention;

FIG. 8 is an AA profile of FIG. 7.

FIG. 9 is a partial profile showing a bearing in accordance with another preferred embodiment of the present invention.

### DETAILED DESCRIPTION OF THE PREFERRED EMBODIMENTS

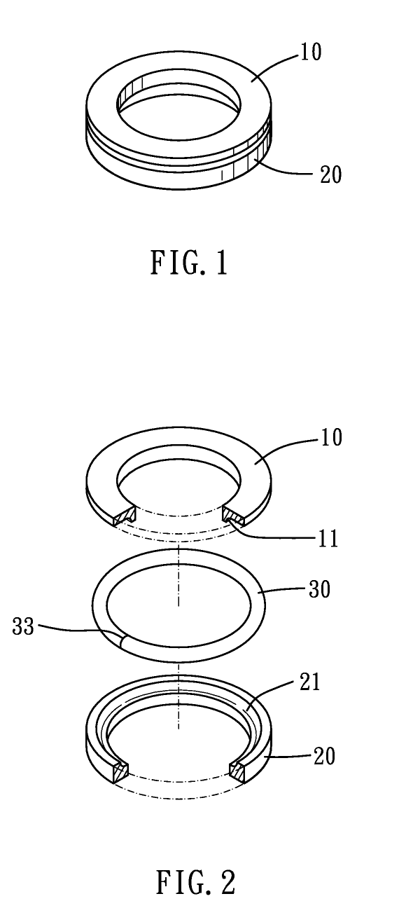

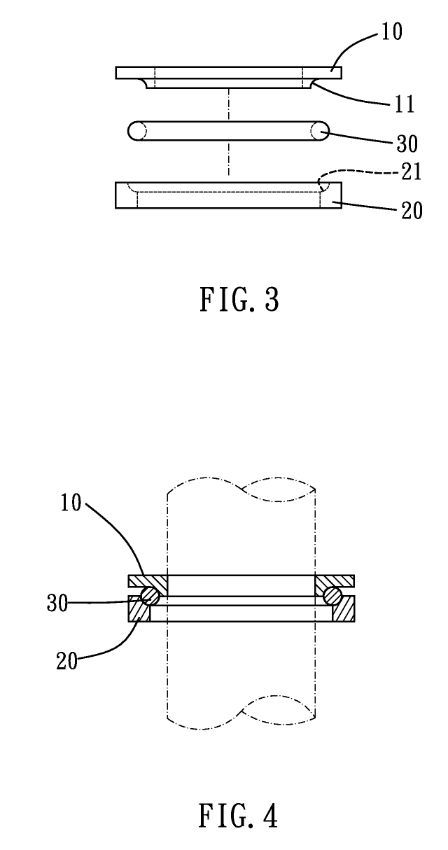

Please refer to FIG. 1 to FIG. 3. A bearing of the present invention includes an inner sleeve 10, an outer sleeve 20 and a slidable gasket 30. The sleeves 20, 30 and the slidable gasket 30 are formed in a substantially annular shape. Each of the sleeves 20, 30 has a stepped portion 11, 21, and an annular receiving space is defined by the stepped portions 11, 21. The slidable gasket 30 is disposed in the receiving space to decrease the friction between the sleeves 10, 20.

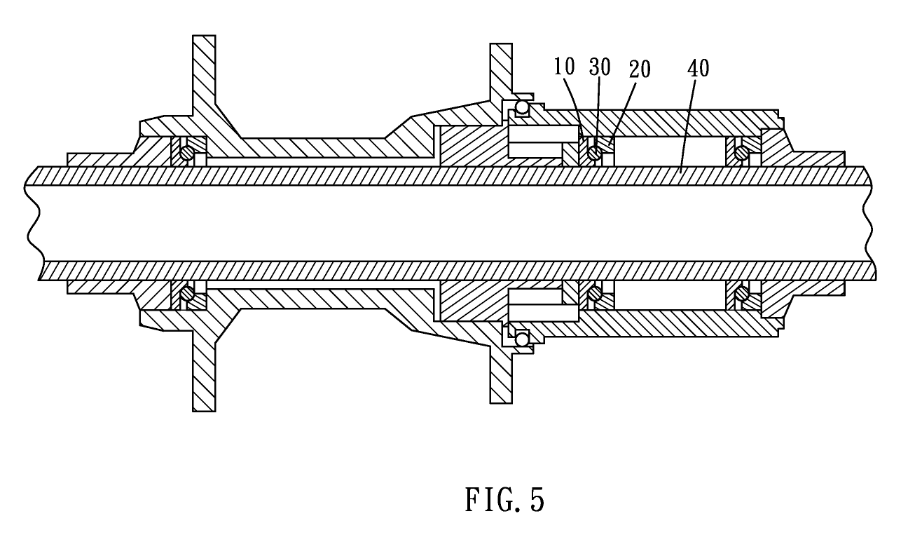

The slidable gasket 30 and the stepped portions 11, 21 are respectively formed with slippery surfaces so as to reduce the friction. It is to be noted that there is not necessary to make a whole periphery of the slidable gasket 30 slippery, i.e. the slidable gasket 30 may be slippery in only a part of its periphery. More specifically, the slidable gasket 30 has a first contact portion and a second contact portion, in which the first and second contact portions are in contact with the inner and outer sleeves 10, 20 respectively. Even if only one of the contact portions has the slippery surface, it is sufficient to reduce the friction between the sleeves 10, 20. This bearing can be simply disposed on the ground or the like surfaces, and an object placed thereon can, therefore, be rotatable about the ground. Or, as shown in FIG. 4 and FIG. 5, the bearing is also suitable to be installed in a bore, and an object 40 can be inserted through the bearing. As such, the object 40 is rotatable about the bore.

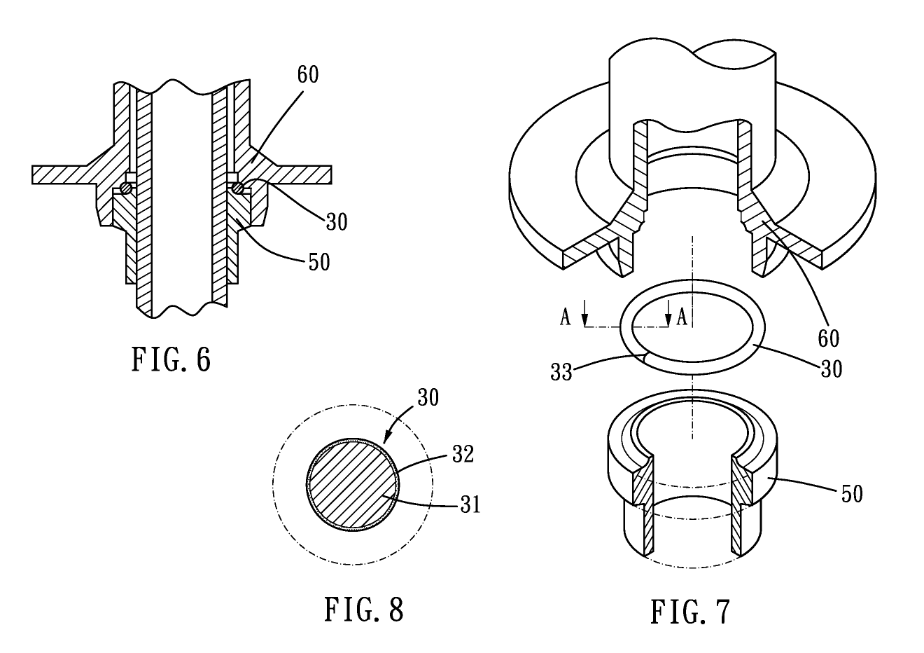

Refer to FIG. 6 and FIG. 7. The slidable gasket 30 can be solely used. The slidable gasket 30 includes an annular main body 31, which can be disposed in a gap between a male element 50 and a female element 60. Refer to FIG. 8, a slippery portion 32 is formed on the periphery of the slidable gasket 30 to enable the elements to rotate about each other. More specifically, the slidable gasket 30 has an inner periphery and an outer periphery, in which the inner periphery faces the center of the slidable gasket 30 and the outer periphery faces the opposite side. It is sufficient for the elements to be rotatable about each other even if only one of the inner and outer peripheries is slippery. Accordingly, the slippery portion reduces the friction between the elements 50, 60, thus enable them to be rotatable about each other. The profile of the slidable gasket 30 can be made to correspond to the shape of the gap between the elements. In the present embodiment, the profile of the slidable gasket 30 is circular; however, it can be formed in other geometric shape to correspond to the gap.

The main body 31 of the slidable gasket 30 can be integrally manufactured to form a seamless surface, so as to further reduce the friction. Or, the main body 31 can be a longitudinal rod being bent into an annular shape, which is more easily manufactured. Accordingly, there will be a seam 33 formed between two terminals of the rod, in which a sensor can be disposed in the seam 33 for positioning purpose or to count the rounds an element rotates thereabout. In addition, the main body is undertaken a surface treatment to form the slippery portion 32.

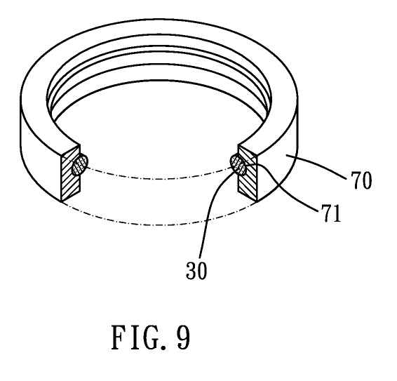

Refer to FIG. 9. A bearing in accordance with another embodiment of the present invention includes a carrier 70 and a slidable gasket 30. The carrier 70 and the slidable gasket 30 are formed in a substantially annular shape. A concave groove 71 is disposed in an inner periphery of the carrier 70, and the slidable gasket 30 is slidably received in the concave groove 71. The periphery of the concave groove and the contact portion of the slidable gasket 30 are undertaken a surface treatment to form slippery surfaces. For manufacturing purpose, the carrier 70 may be divided into several assemblable sub carriers.

The surface treatment is selected from a group consisting of polishing, precision grinding, anodizing, electroplating and a combination thereof. As such, the frictional index of the surface of the slidable gasket or other parts undertaken the surface treatment is lowered to become slippery.

In summarization, the slidable gasket of the present invention undertakes a surface treatment to lower its frictional index. As such, it is slippery without the help of lubricating oil, balls or rollers, which leads to service life extension and reduced noise of the bearing.

What is claimed is:

1. A slidable gasket, comprising an annular main body to be disposed in a gap between a male element and a female element, the main body having an inner periphery and an outer periphery, the inner periphery facing a center of the main body, and the outer periphery facing an opposite direction of the inner periphery, at least one of the inner periphery and the outer periphery being formed with a slippery portion to decrease the friction between the main body and said elements, whereby the male element and the female element are rotatable about each other.

2. The slidable gasket of claim 1, wherein the main body is a longitudinal rod being bent into an annular shape and undertaken a surface treatment, and a seam is formed between two terminals of the rod.

3. The slidable gasket of claim 1, wherein the main body is integrally formed and undertaken a surface treatment.

4. The slidable gasket of claim 2, wherein the surface treatment is selected from a group consisting of polishing, precision grinding, anodizing, electroplating and a combination thereof.

5. The slidable gasket of claim 3, wherein the surface treatment is selected from a group consisting of polishing, precision grinding, anodizing, electroplating and a combination thereof.

6. A bearing, comprising an inner sleeve, an outer sleeve and a slidable gasket, the sleeves and the slidable gasket being formed in a substantially annular shape, each of the sleeves having a stepped portion, and an annular receiving space being defined by the stepped portions, the slidable gasket being disposed in the receiving space to decrease the friction between the sleeves.

7. The bearing of claim 6, wherein the slidable gasket has a first contact portion and a second contact portion, the first contact portion is in contact with the inner sleeve, and the second contact portion is in contact with the outer sleeve, at least one of the contact portions is formed with a slippery surface.

8. The bearing of claim 7, wherein the slippery surface is undertaken a surface treatment which is selected from a group consisting of polishing, precision grinding, anodizing, electroplating and a combination thereof.

9. A bearing, comprising a carrier and a slidable gasket, the carrier and the slidable gasket being formed in a substantially annular shape, a concave groove being disposed in an inner periphery of the carrier, the slidable gasket being slidably disposed in the concave groove.

10. The bearing of claim 9, wherein the carrier is composed of several sub carriers.

11. The bearing of claim 9, wherein the slidable gasket has a contact portion being in contact with the concave groove, the concave groove and the contact portion are undertaken a surface treatment which is selected from a group consisting of polishing, precision grinding, anodizing, electroplating and a combination thereof.

12. The bearing of claim 10, wherein the slidable gasket has a contact portion being in contact with the concave groove, the concave groove and the contact portion are undertaken a surface treatment which is selected from a group consisting of polishing, precision grinding, anodizing, electroplating and a combination thereof.
